(19) United States
(12) Patent Application Publication
(10) Pub. No.: US 2019/0075870 A1
(43) Pub. Date: Mar. 14, 2019

(54) SYNTHETIC BRAIDING HAIR AND ITS MANUFACTURING METHOD

(71) Applicant: Hyun HAN, Fort Worth, TX (US)

(72) Inventor: Hyun HAN, Fort Worth, TX (US)

(21) Appl. No.: 15/703,985

(22) Filed: Sep. 14, 2017

(51) Int. Cl. A41G 5/00; D04C 1/06; D04C 1/02; A45D 8/34

(52) U.S. Cl. CPC A41G 5/004; D04C 1/06; A61Q 5/06; A45D 8/34; D04C 1/02

(57) ABSTRACT

A synthetic braiding hair and its manufacturing method are disclosed. A synthetic braiding hair creating a faux locs style and a bohemian hair style simultaneously is comprised of the plurality of the first synthetic fibers spirally wound to create a faux locs hair style, the plurality of the second synthetic fibers spirally wound simultaneously along the plurality of the first synthetic fibers and extended at one end longer than the plurality of the first synthetic fibers to create a bohemian hair style thereof, and a hook formed at the other end of the plurality of the first synthetic fibers.

### FIELD OF THE INVENTION

The present invention relates to a new synthetic braiding hair and its manufacturing method, more specifically, the proposed synthetic braiding hair is attached to natural human hair so that it is intended for achieving various color and hair style in hair design.

### BACKGROUND OF THE INVENTION

The hair style for woman has been created and changed for many years according to the need of new styles in hair design industries. The development of synthetic hair products has led to continuous introduction of new hair styles to beauty and hair design market. The braiding hair product is normally attached to a natural human hair by braiding or stitching with a special hair needle. Most of the hair style products in the market has been aimed for how to easily attach the synthetic hair to the natural hair and these kind of braiding tools have been usefully utilized based on their purposes. As various types of synthetic hair products have been changed in market, the creation of new braiding hair style products is still in great need.

So far, most of prior arts in US patents has been only focused on the device for braiding method of natural or synthetic hair itself. U.S. Pat. No. 5,497,795 suggested the use of the flexible loop to prevent natural hair being loosen from the normal braiding method with the step of selecting a braiding aid having a plurality of flexible and resilient loops, each loop connected to the next loop in a series and each loop being individually expandable.

US Publication No. 2008/0163882 disclosed the braid hair weft that attaches the plurality of synthetic hair to a series of string to reduce the braiding time. The apparatus was designed to reduce the length of time it takes to add hair extensions and braid individual braids to a person's head. The present invention requires anchoring hair fibers to a weft creating an apparatus for quickly adding the look of individual braids without requiring one to individually braid strands of a person's hair.

U.S. Pat. No. 9,439,498 introduced a flexible tube to embrace the braided hair to protect the natural braid hair from environment by providing a lengthwise contractible cylindrical evolved hair tube, where the hair tube is resiliently biased toward a preformed state.

These references through US patents provided improved methods and devices how to braid natural hair or synthetic hair extension in easier way, but disclosing any new braiding hair style product and its developing methodology have not been suggested yet. So, hair designers in many hair design shops create new hair style manually by braiding and extending several different existing style of synthetic hair products together. This method of braiding has been popularly used in African-American hair shops.

Instead of suggesting another tool or device to create new hair braiding, the present invention discloses a new synthetic braiding hair which is pre-formed two hair styles into one and the manufacturing method thereof. So, the consumer is able to attach the proposed synthetic braiding hair onto his/her natural hair with a conventional method to create a unique and new combined hair style easily.

To understand the creativity of the present invention, there needs a review for the existing hair styles in the market and how noble and new the present invention is compared to the prior art.

For many years, one of the most famous braiding hair styles in hair design industries is called faux locs hair. The faux locs synthetic hair is pre-formed as it is spirally wound to form a 0.2 inch-0.5 inch diameter cylindrical shape. The faux locs synthetic hair contains a bundle of cylindrical shaped synthetic hairs in one product package. The inside of the faux locs synthetic hair is vacant such as a tube. Thus, the faux locs synthetic hair style gives an abundant volumetric hair style with its vacant space inside.

Each of faux locs hair is attached to the natural hair by braiding or stitching with a special hair needle. The FIG. 1(a) shows a woman who has faux locs synthetic hair on her head. Also, the FIG. 1(b) is a picture of faux locs hair product currently in beauty supply market. The thickness of faux locs synthetic hair is various with different diameters of spiral winding method.

Another famous braiding hair style is called bohemian hair style. The bohemian synthetic hair is pre-formed as it is permanently shaped to wave. Like other hair product, this bohemian synthetic hair is attached to the natural human hair with braiding or stitching. The waviness of the bohemian style can vary according to the waviness of the synthetic hair. The FIG. 2(a) shows a woman who has bohemian synthetic hair attached on her natural hair. Also, the FIG. 2(b) is a picture of a bohemian hair product currently in beauty supply market. The feature of this hair style is to express the natural wave on hair compared to the faux locs hair.

Recently, there were many people who tried to combine faux locs and bohemian locs altogether to create a new hair style. They attached the faux locs and bohemian hair with braiding at the same time to show the combined new style. From the root of attachment of hair to some length, the faux locs hair style is displayed, and from the end of faux locs to some extent, bohemian hair style is shown. FIG. 3(a) depicts a woman who has a faux locs and bohemian hair style simultaneously. People usually used one of two following methods to create the combined hair style.

The first method is, as shown in FIG. 3(b), to attach a bohemian synthetic hair to the natural human hair by braiding or stitching. Then, a faux locs synthetic hair is also attached to the same location of the natural human hair by braiding or stitching. With a special hair tool, the bohemian synthetic hair is hooked to the special hair tool, then it is drawn to the end of the faux locs hair, resulting in the bohemian hair is put inside the vacant space of the faux locs synthetic hair. At the end of the faux locs, the bohemian hair comes out through the vacant space of the faux locs. The final hair style is made to show that the faux locs style is shown from the root of the natural human hair to some extent, and the bohemian style is shown from the end of the faux locs to the end of hair.

The second method is, as shown in FIG. 3(c), a bohemian synthetic hair is attached to the natural human hair by braiding or stitching. Then, a faux locs synthetic hair is also attached at the same location of the natural human hair by braiding or stitching. The faux locs synthetic hair is loosen, then it is rewound around the bohemian synthetic hair by hand. The bohemian synthetic hair is getting into the faux locs synthetic hair as the faux locs synthetic hair is spirally wound along the bohemian synthetic hair, creating same style mentioned in the first method.

There are several disadvantages when using these methods. Firstly, as the faux locs and bohemian synthetic hairs are attached at the same location of the natural human hair individually, the weight of those synthetic hairs onto the natural hair and the skin are twice heavier than when one synthetic hair is attached. This eventually causes a weight burden onto the natural human hair and skin and sometimes gives a skin irritation and headache to the user. Also, there needs that braiding time of each faux locs and bohemian hair takes two times longer than attaching one synthetic hair in hair design shop. Lastly, people need to buy two products to have the combined hair style, which costs two times more than buying one.

### DISCLOSURE OF THE INVENTION

To overcome several issues caused by using two braiding synthetic hair products to create a new hair style, the objective of present disclosure is to develop a new braiding synthetic hair that achieve faux locs and bohemian hair style at once with one product. Using the new synthetic hair proposed in this disclosure, people can create a combined faux locs and bohemian hair style at the same time with only one attachment of the product to the natural human hair.

Also, with the use of a new synthetic fiber, the weight of the combined hair product is much lighter than the combined two synthetic hair products. This will give much less weight onto the natural human hair and allow the people to have same combined style without any damage to hair or skin. Lastly, people can show the combined hair style more economically than buying two products to do the same.

In accordance with the illustrative embodiment in the disclosure, there is provided a synthetic braiding hair to create a faux locs and a bohemian hair style simultaneously, the synthetic braiding hair comprising, a plurality of the first synthetic fibers spirally wound to create a faux locs hair style, a plurality of the second synthetic fibers spirally wound simultaneously along the plurality of the first synthetic fibers and extended at one end longer than the plurality of the first synthetic fibers to create a bohemian hair style thereof and a hook formed at the other end of the plurality of the first synthetic fibers.

In the present disclosure, the faux locs hair style is made by spirally winding the plurality of the first synthetic fibers to form a cylindrical shape with a vacant space inside.

The bohemian hair style is made by forming waviness at an extended part of the plurality of the second synthetic fibers. And the hook is used for attaching the synthetic braiding hair to natural human hair by braiding or stitching.

In the present disclosure, the plurality of the first synthetic fibers and the plurality of the second synthetic fibers are aligned and wound simultaneously in such a way that the plurality of the first synthetic fibers is wound outside of the cylinder shape and the plurality of the second synthetic fibers is wound inside of the cylinder shape to prevent any kink.

In the present disclosure, the plurality of the first synthetic fibers is made by polyolefin compounds to create light and volumetric synthetic hairs.

The plurality of the second synthetic fibers is made by polyethylene terephthalate compounds to create light and wavy synthetic hairs.

In the present disclosure, the plurality of the first and second synthetic fibers after being wound together are put into a heat oven to form a permanent shape of faux locs.

The extended part of the plurality of the second synthetic fibers is pressed with a heated wave forming device to form a permanent shape of the bohemian style.

### BRIEF DESCRIPTION OF THE DRAWINGS

FIG. 1(a) is a conceptual picture for a prior art, showing a woman with a faux locs hair attached to her natural hair, and FIG. 1(b) is a picture of the faux locs synthetic hair product in sale.

FIG. 2(a) is a conceptual picture for a prior art, showing a woman with a bohemian hair attached to her natural hair, and FIG. 2(b) is a picture of the bohemian synthetic hair product in sale.

FIG. 3(a) is a conceptual picture for a prior art, showing a woman with a combined faux locs and bohemian hair attached to her natural hair.

FIG. 3(b) is a conceptual diagram for a prior art, describing the first method to attach the faux locs and bohemian synthetic hair onto the natural hair and how to insert the bohemian hair into the vacant space of the faux locs hair using a special hair needle.

FIG. 3(c) is a conceptual diagram for a prior art, describing a second method to attach the faux locs and bohemian synthetic hair onto the natural hair and how to insert the bohemian hair into the vacant space of the faux locs hair by winding the faux locs hair around the bohemian hair.

FIG. 4 is a conceptual diagram for describing how to manufacture the new braiding hair presented in this invention.

FIG. 5 is a cross sectional view of the winding procedure, depicting how the first fiber is wound outer side of the cylindrical shape and how the second fiber is wound inner side of the cylindrical shape.

FIG. 6 is a chart of manufacturing method for the present invention.

### DETAILED DESCRIPTION OF THE INVENTION

Hereinafter, illustrative embodiments and examples will be described in detail so that inventive concept may be readily implemented by those skilled in the art. However, it is to be noted that the present disclosure is not limited to the illustrative embodiments and examples but can be realized in various other ways. In drawings, parts not directly relevant to the description are omitted to enhance the clarity of the drawings, and like reference numerals denote like parts through the whole document.

Through the whole document, the term “on” that is used to designate a position of one element with respect to another element includes both a case that the one element is adjacent to the another element and a case that any other element exists between these two elements.

Through the whole document, the term “comprises or includes” and/or “comprising or including” used in the document means that one or more other components, steps, operation and/or existence or addition of elements are not excluded in addition to the described components, steps, operation and/or elements unless context dictates otherwise. The term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party. Through the whole document, the term “step of” does not mean “step for”.

Through the whole document, the term “combination of” included in Markush type description means mixture or combination of one or more components, steps, operations and/or elements selected from the group consisting of components, steps, operation and/or elements described in Markush type and thereby means that the disclosure includes one or more components, steps, operations and/or elements selected from the Markush group.

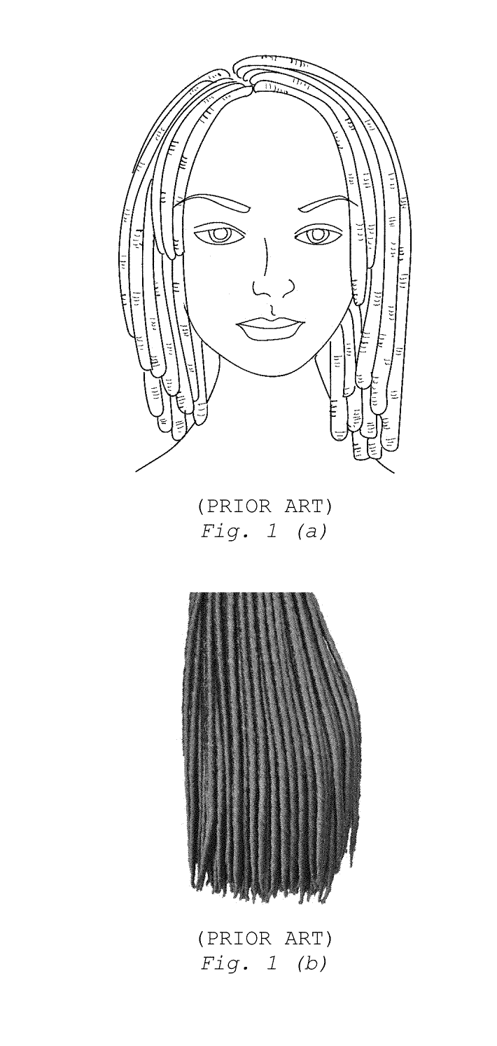

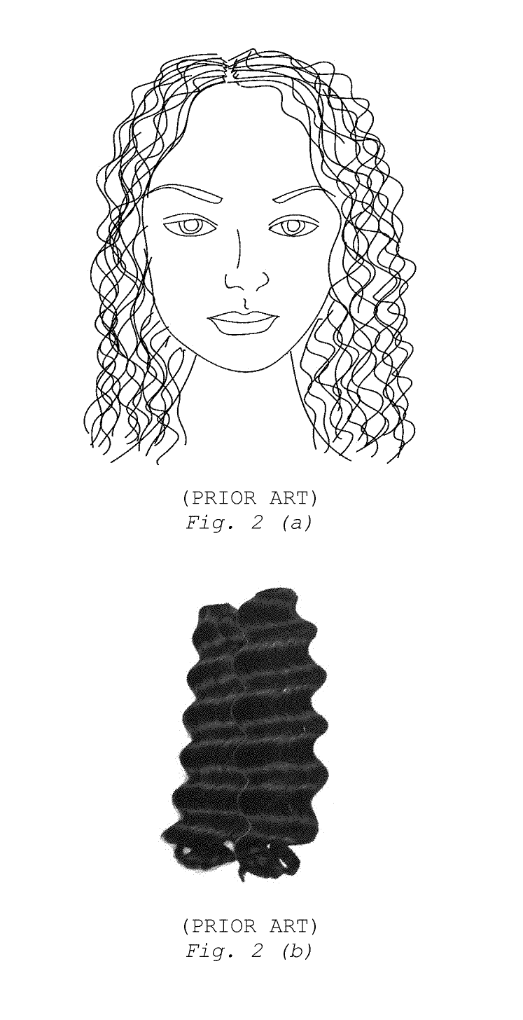

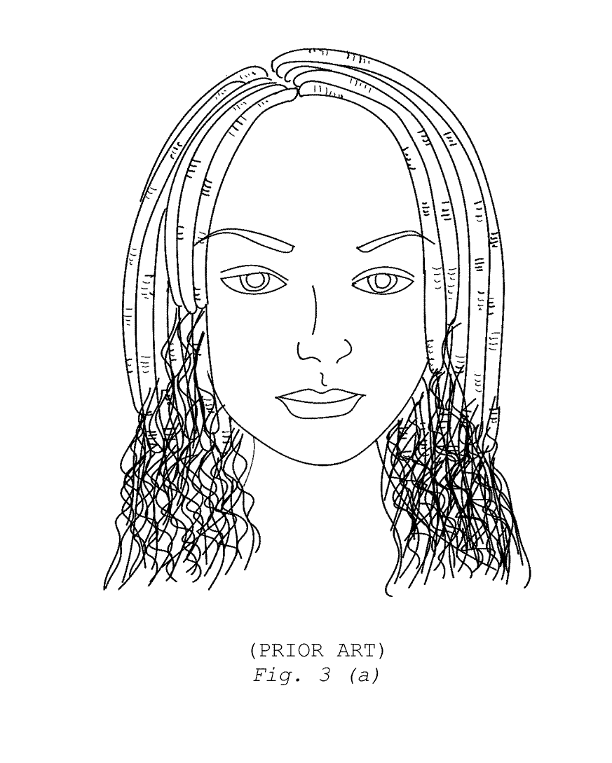

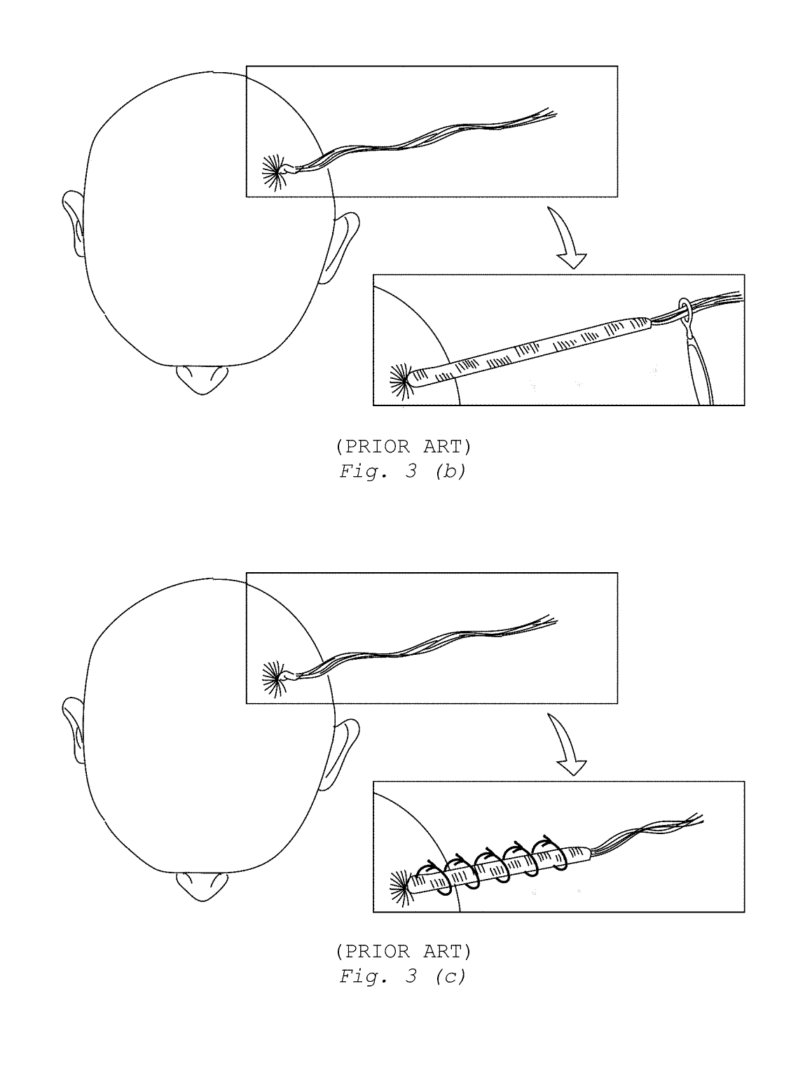

Further, in the following description of illustrative embodiments, terms related to a direction or a position (upper side, lower side, up and down directions, etc.) are defined with respect to the arrangement state of individual components shown in drawings. For example, the “upper side” and the “lower side” may be defined as the upper side and the lower side when viewed from FIG. 1, that is, the “left side” and the “right side” on a paper plane. However, it should be noted that when the illustrative embodiment is practically applied, the components may be arranged in various directions with the upper side and the lower side reversed, for example.

Below, illustrative embodiments and examples of the present disclosure will be described in detail.

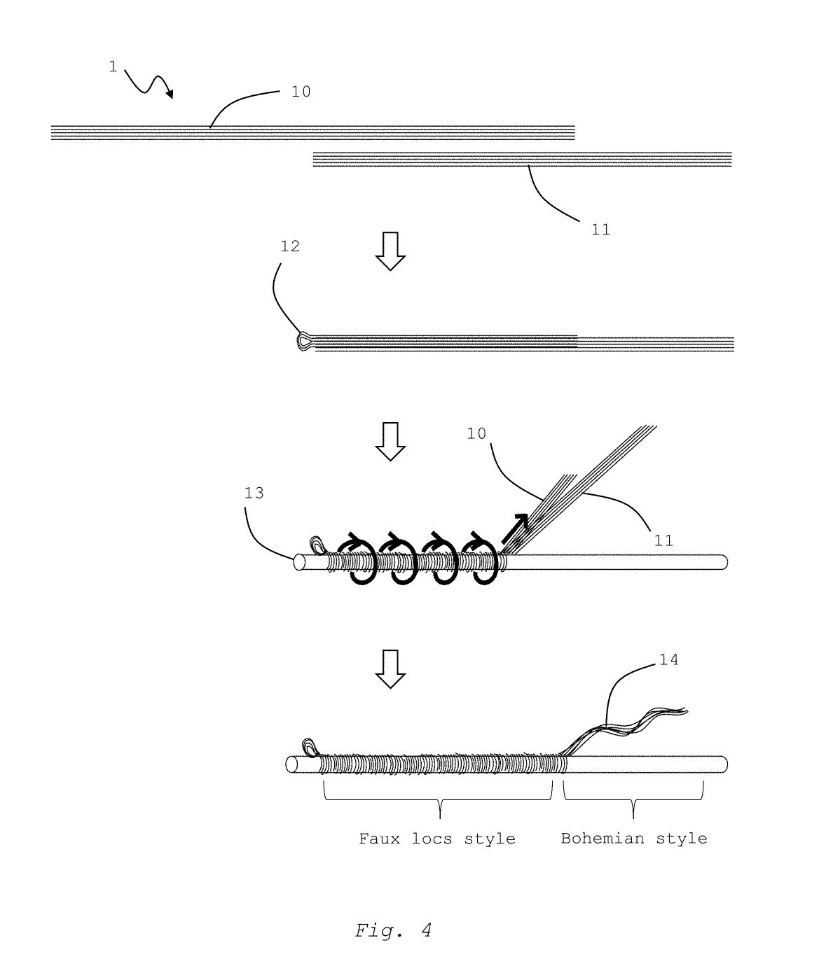

In FIG. 4, a synthetic braiding hair (1) to create a faux locs and a bohemian hair style simultaneously is comprised of a plurality of the first synthetic fibers (10) and a plurality of the second synthetic fibers (11). The plurality of the first synthetic fibers (10) is aligned at one end of the plurality of the second synthetic fibers (11). The plurality of the first synthetic fibers (10) is folded in the middle to form a hook (12). The plurality of the first synthetic fibers (10) and the plurality of the second synthetic fibers (11) then are wound spirally along a cylindrical rod (13) to create a faux locs hair style.

The plurality of the first synthetic fibers (10) and the plurality of the second synthetic fibers (11) are spirally wound simultaneously. The plurality of the second synthetic fibers (11) is extended at one end longer than the plurality of the first synthetic fibers (10) to create a bohemian hair style thereof.

The faux locs hair style is made by spirally winding the plurality of the first and the second synthetic fibers (10, 11) to form a cylindrical shape with a vacant space inside. The bohemian hair style is made by forming waviness at an extended part of the plurality of the second synthetic fibers (14).

The hook (12) is used for attaching the synthetic braiding hair (1) to natural human hair by braiding or stitching.

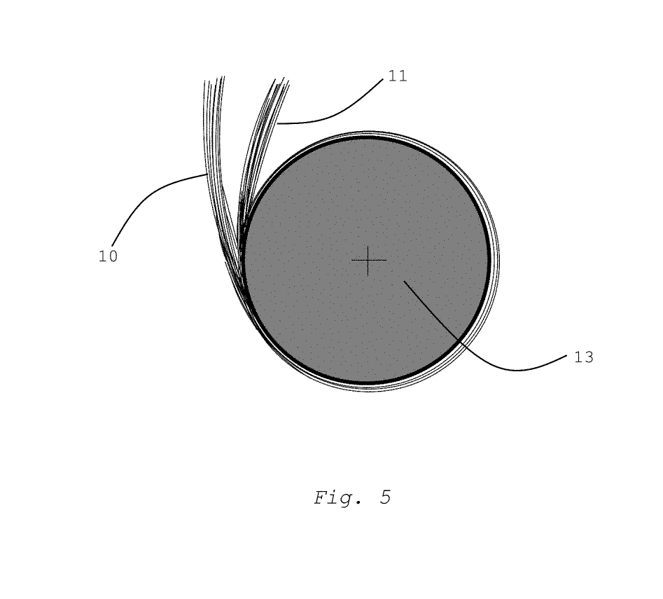

In FIG. 5, the plurality of the first synthetic fibers (10) and the plurality of the second synthetic fibers (11) are aligned and wound simultaneously in such a way that the plurality of the first synthetic fibers (10) is wound outer side of cylindrical shape and the plurality of the second synthetic fibers (11) is wound inner side of cylindrical shape to prevent any kink.

The plurality of the first synthetic fibers (10) is made by polyolefin compounds to create light and volumetric synthetic hairs.

The plurality of the first synthetic fibers (10) using polyolefin compounds is much lighter in weight compared to the conventional faux locs hair product, resulting in less weight burden onto the natural human hair when it is attached.

The plurality of the second synthetic fibers (11) is made by polyethylene terephthalate compounds to create light and wavy synthetic hairs.

The plurality of the second synthetic fibers (11) using polyethylene terephthalate compounds is much lighter in weight compared to the conventional bohemian hair product, also resulting in less weight burden onto the natural human hair when it is attached.

The plurality of the first synthetic fibers (10) and the plurality of the second synthetic fibers (11) after being wound together are put into a heat oven to form a permanent shape of the faux locs style.

The extended part of the plurality of the second fibers (14) are pressed with a heated wave-forming device to form a permanent shape of the bohemian style.

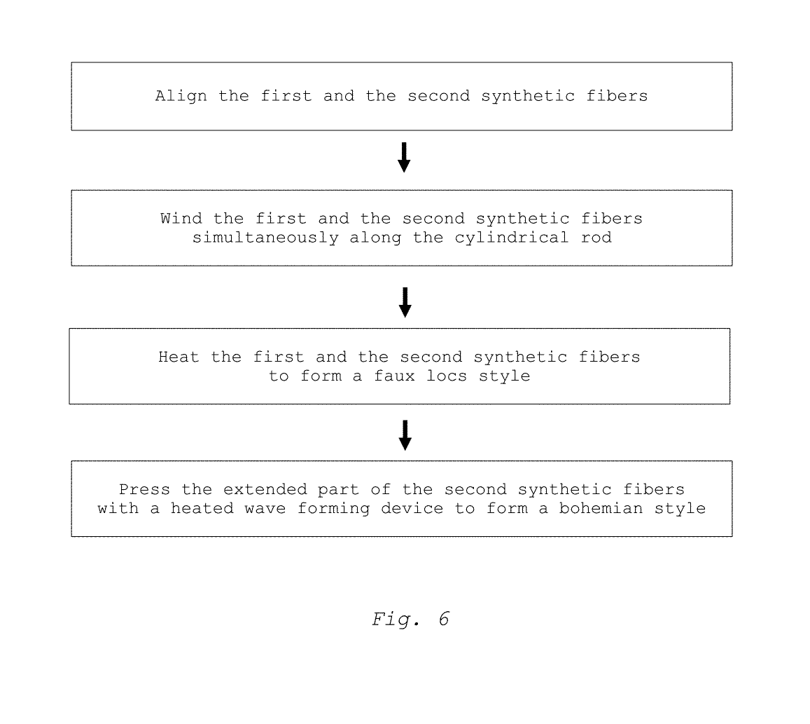

To manufacture the synthetic braiding hair disclosed herein, the procedure of the following method is suggested. The diagram in FIG. 6 shows the step by step procedure of manufacturing in detail.

Firstly, a plurality of the first synthetic fibers (10) and a plurality of the second synthetic fibers (11) are aligned such that one end of the plurality of the second synthetic fibers (11) is located to the middle of the plurality of the first synthetic fibers (10). The plurality of the first synthetic fibers (10) is folded in the middle to form a hook (12). The plurality of the first synthetic fibers (10) and the plurality of the second synthetic fibers (11) then are wound spirally along a cylindrical rod (13) to create a faux locs hair style. The plurality of the first fibers (10) and the plurality of the second synthetic fibers (11) are put into a heat oven to form a permanent shape of faux locs style; then an extended part of the plurality of the second synthetic fibers (14) is pressed with a heated wave-forming device to form a permanent shape of the bohemian style.

The step of winding the plurality of the first and the second synthetic fibers (10, 11) includes winding spirally to form a cylindrical shape with a vacant space inside.

The step of winding the plurality of the first and the second synthetic fibers (10, 11) includes extending one end of the plurality of the second synthetic fibers.

The step of winding the plurality of the first and the second synthetic fibers (10, 11) includes aligning the plurality of the first synthetic fibers (10) to be wound outer side of the cylindrical rod (13) and the plurality of the second synthetic fibers (11) to be wound inner side of the cylindrical rod (13) to prevent overlap and kink.

The step of winding the plurality of the first synthetic fibers (10) includes selecting the plurality of the first synthetic fibers (10) made by polyolefin compounds to create light and volumetric synthetic hairs.

The step of winding the plurality of the second synthetic fibers (11) includes selecting the plurality of the second synthetic fibers (11) made by polyethylene terephthalate compounds to create light and wavy synthetic hairs.

The above description of the illustrative embodiments is provided for the purpose of illustration, and it would be understood by those skilled in the art that various changes and modifications may be made without changing technical conception and essential features of the illustrative embodiments. Thus, it is clear that the above-described illustrative embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the illustrative embodiments. It shall be understood that all modifications and embodiments conceived from the meaning and scope of the claims and their equivalents are included in the scope of the inventive concept.

We claim:

1. A synthetic braiding hair to create a faux locs and a bohemian hair style simultaneously, the synthetic braiding hair comprising:
a plurality of the first synthetic fibers spirally wound to create a faux locs hair style;
a plurality of the second synthetic fibers spirally wound simultaneously along the plurality of the first synthetic fibers and extended at one end longer than the plurality of the first synthetic fibers to create a bohemian hair style thereof; and
a hook formed at the other end of the plurality of the first synthetic fibers.

2. The synthetic braiding hair of claim 1,
wherein the faux locs hair style is made by spirally winding the plurality of the first synthetic fibers and the plurality of the second synthetic fibers to form a cylindrical shape with a vacant space inside.

3. The synthetic braiding hair of claim 1,
wherein the bohemian hair style is made by forming waviness at an extended part of the plurality of the second synthetic fibers.

4. The synthetic braiding hair of claim 1,
wherein the hook is used for attaching the synthetic braiding hair to natural human hair by braiding or stitching.

5. The synthetic braiding hair of claim 1,
wherein the plurality of the first synthetic fibers and the plurality of the second synthetic fibers are aligned and wound simultaneously in such a way that the plurality of the first synthetic fibers is wound outer side of the cylindrical shape and the plurality of the second synthetic fibers is wound inner side of the cylindrical shape to prevent overlap and kink.

6. The synthetic braiding hair of claim 1,
wherein the plurality of the first synthetic fibers is made by polyolefin compounds to create lighter and volumetric synthetic hairs compared to conventional synthetic fibers.

7. The synthetic braiding hair of claim 1,
wherein the plurality of the second synthetic fibers is made by polyethylene terephthalate compounds to create lighter and wavy synthetic hairs compared to conventional synthetic fibers.

8. The synthetic braiding hair of claim 1,
wherein the plurality of the first synthetic fibers and the plurality of the second synthetic fibers after being wound together are put into a heat oven to form a permanent shape of the faux locs style.

9. The synthetic braiding hair of claim 8,
wherein the extended part of the plurality of the second fibers is pressed with a heated wave-forming device to form a permanent shape of the bohemian style.

10. A method of a synthetic braiding hair comprising the steps of:
aligning a plurality of the first synthetic fibers and a plurality of the second synthetic fibers;
folding the plurality of the first synthetic fibers in the middle to form a hook;
winding the plurality of the first and the second synthetic fibers spirally along a cylindrical rod to create a faux locs style;
putting the plurality of the first and the second synthetic fibers into a heat oven to form a permanent shape of faux locs style; and
pressing an extended part of the plurality of the second synthetic fibers with a heated wave-forming device to form a permanent shape of the bohemian style.

11. The method of a synthetic braiding hair in claim 10 in which the step of winding the plurality of the first and the second synthetic fibers includes winding spirally to form a cylindrical shape with a vacant space inside.

12. The method of a synthetic braiding hair in claim 10 in which the step of winding the plurality of the first and the second synthetic fibers includes extending one end of the plurality of the second synthetic fibers.

13. The method of a synthetic braiding hair in claim 10 in which the step of winding the plurality of the first and the second synthetic fibers includes aligning the plurality of the first synthetic fibers to be wound outer side of the cylindrical rod and the plurality of the second synthetic fibers to be wound inner side of the cylindrical rod to prevent overlap and kink.

14. The method of a synthetic braiding hair in claim 10 in which the step of winding the plurality of the first synthetic fibers includes selecting the plurality of the first synthetic fibers made by polyolefin compounds to create lighter and volumetric synthetic hairs compared to conventional fibers.

15. The method of a synthetic braiding hair in claim 10 in which the step of winding the plurality of the second synthetic fibers includes selecting the plurality of the second synthetic fibers made by polyethylene terephthalate compounds to create lighter and wavy synthetic hairs compared to conventional fibers.
